(19) United States
(12) Patent Application Publication
(10) Pub. No.: US 2026/0136293 A1
(43) Pub. Date: May 14, 2026

(54) METHOD AND APPARATUS FOR ENABLING WAKE-UP SIGNAL FUNCTION, TERMINAL, AND NETWORK SIDE DEVICE

(71) Applicant: VIVO MOBILE COMMUNICATION CO., LTD., Dongguan (CN)

(72) Inventors: Yangyang WANG, Dongguan (CN); Xueming PAN, Dongguan (CN)

(73) Assignee: VIVO MOBILE COMMUNICATION CO., LTD., Dongguan (CN)

(21) Appl. No.: 19/442,980

(22) Filed: Jan. 7, 2026

Related U.S. Application Data
(63) Continuation of application No. PCT/CN2024/102812, filed on Jul. 1, 2024.

(30) Foreign Application Priority Data
Jul. 7, 2023 (CN) 202310832104.8

(51) Int. Cl. H04W 52/02; H04W 68/00

(52) U.S. Cl. CPC H04W 52/0235; H04W 68/00

(57) ABSTRACT

A method and an apparatus for enabling a wake-up signal function, a terminal, and a network side device are provided. The method for enabling a wake-up signal function includes: obtaining, by a terminal, target information, and determining, by the terminal based on the target information, whether to enable the wake-up signal function. The target information includes any one of following: first information sent by an access network device or a core network device, or second information sent by an access network device. The first information is used to indicate to enable a wake-up signal function of the terminal. The second information is used to indicate a type of a terminal that enables or does not enable a wake-up signal function in terminals that access a cell corresponding to the access network device.

### CROSS-REFERENCE TO RELATED APPLICATIONS

This application is a continuation of International Application No. PCT/CN2024/102812, filed on Jul. 1, 2024, which claims priority to Chinese Patent Application No. 202310832104.8, filed on Jul. 7, 2023. The entire contents of each of the above-referenced applications are expressly incorporated herein by reference.

### TECHNICAL FIELD

This application pertains to the field of communication technologies, and specifically, to a method and an apparatus for enabling a wake-up signal function, a terminal, and a network side device.

### BACKGROUND

With the development of communication technologies, a Low-Power Wake-Up Receiver (LP-WUR) is introduced in a mobile communication terminal to receive a low-power signal. This allows a main communication module to remain in an off state or an ultra-deep sleep state, thereby effectively reducing power consumption of the terminal. The low-power signal includes a Low-Power Wake-Up Signal (LP-WUS). Currently, a network side device usually enables a wake-up signal service for all terminals accessing a cell associated with the network side device. Therefore, when paging a terminal, the network side device needs to send both a wake-up signal and a paging message, resulting in high signaling overheads for paging.

### SUMMARY

Embodiments of this application provide a method and an apparatus for enabling a wake-up signal function, a terminal, and a network side device.

According to a first aspect, a method for enabling a wake-up signal function is provided. The method includes:

A terminal obtains target information; and
the terminal determines, based on the target information, whether to enable a wake-up signal function.

The target information includes any one of following:
first information sent by an access network device or a core network device, where the first information is used to indicate to enable the wake-up signal function of the terminal; and
second information sent by an access network device, where the second information is used to indicate a type of a terminal that enables or does not enable a wake-up signal function in terminals that access a cell corresponding to the access network device.

According to a second aspect, a method for enabling a wake-up signal function is provided. The method includes:

An access network device sends target information to a terminal.

The target information includes any one of following:
first information, where the first information is used to indicate to enable a wake-up signal function of the terminal; and
second information, where the second information is used to indicate a type of a terminal that enables or does not enable a wake-up signal function in terminals that access a cell corresponding to the access network device.

According to a third aspect, a method for enabling a wake-up signal function is provided. The method includes:

A core network device performs a target operation.

The target operation includes any one of following:
sending first information to a terminal; and
sending fourth information to an access network device, where the fourth information is used to assist the access network device in sending second information to the terminal.

The first information is used to indicate to enable the wake-up signal function of the terminal, and the second information is used to indicate a type of a terminal that enables or does not enable a wake-up signal function in terminals that access a cell corresponding to the access network device.

According to a fourth aspect, an apparatus for enabling a wake-up signal function is provided. The apparatus includes:
a first receiving module, configured to obtain target information; and
a first determining module, configured to determine, based on the target information, whether to enable a wake-up signal function.

The target information includes any one of following:
first information sent by an access network device or a core network device, where the first information is used to indicate to enable a wake-up signal function of a terminal; and
second information sent by an access network device, where the second information is used to indicate a type of a terminal that enables or does not enable a wake-up signal function in terminals that access a cell corresponding to the access network device.

According to a fifth aspect, an apparatus for enabling a wake-up signal function is provided. The apparatus includes:
a second sending module, configured to send target information to a terminal.

The target information includes any one of following:
first information, where the first information is used to indicate to enable a wake-up signal function of the terminal; and
second information, where the second information is used to indicate a type of a terminal that enables or does not enable a wake-up signal function in terminals that access a cell corresponding to an access network device.

According to a sixth aspect, an apparatus for enabling a wake-up signal function is provided. The apparatus includes:
an execution module, configured to perform a target operation.

The target operation includes any one of following:
sending first information to a terminal; and
sending fourth information to an access network device, where the fourth information is used to assist the access network device in sending second information to the terminal.

The first information is used to indicate to enable the wake-up signal function of the terminal, and the second information is used to indicate a type of a terminal that enables or does not enable a wake-up signal function in terminals that access a cell corresponding to the access network device.

According to a seventh aspect, a terminal is provided. The terminal includes a processor and a memory, the memory stores a program or an instruction that can be run on the processor, and the program or the instruction is executed by the processor to implement the steps of the method according to the first aspect.

According to an eighth aspect, a terminal is provided, including a processor and a communication interface.

The communication interface is configured to obtain target information.

The processor is configured to determine, based on the target information, whether to enable a wake-up signal function.

The target information includes any one of following:
first information sent by an access network device or a core network device, where the first information is used to indicate to enable the wake-up signal function of the terminal; and
second information sent by an access network device, where the second information is used to indicate a type of a terminal that enables or does not enable a wake-up signal function in terminals that access a cell corresponding to the access network device.

According to a ninth aspect, a network side device is provided, where the network side device includes a processor and a memory, the memory stores a program or an instruction that can be run on the processor, and when the program or the instruction is executed by the processor, the steps of the method according to the second aspect or the steps of the method according to the third aspect are implemented.

According to a tenth aspect, a network side device is provided, including a processor and a communication interface.

When the network side device is an access network device, the communication interface is configured to send target information to a terminal.

The target information includes any one of following:
first information, where the first information is used to indicate to enable a wake-up signal function of the terminal; and
second information, where the second information is used to indicate a type of a terminal that enables or does not enable a wake-up signal function in terminals that access a cell corresponding to the access network device.

When the network side device is a core network device, the communication interface is configured to perform a target operation.

The target operation includes any one of following:
sending first information to a terminal; and
sending fourth information to an access network device, where the fourth information is used to assist the access network device in sending second information to the terminal.

The first information is used to indicate to enable the wake-up signal function of the terminal, and the second information is used to indicate a type of a terminal that enables or does not enable a wake-up signal function in terminals that access a cell corresponding to the access network device.

According to an eleventh aspect, a readable storage medium is provided. The readable storage medium stores a program or an instruction, and the program or the instruction is executed by a processor to implement steps of the method according to the first aspect, the second aspect, or the third aspect.

According to a twelfth aspect, a wireless communication system is provided. The wireless communication system includes a terminal and a network side device. The terminal may be configured to perform the steps of the method according to the first aspect, and the network side device may be configured to perform the steps of the method according to the second aspect or the third aspect.

According to a thirteenth aspect, a chip is provided. The chip includes a processor and a communication interface. The communication interface is coupled to the processor. The processor is configured to run a program or an instruction, to implement the steps of the method according to the first aspect, the steps of the method according to the second aspect, or the steps of the method according to the third aspect.

According to a fourteenth aspect, a computer program/program product is provided. The computer program/program product is stored in a storage medium, and the program/program product is executed by at least one processor to implement the method according to the first aspect, or the method according to the second aspect, or the of the method according to the third aspect.

In embodiments of this application, the terminal obtains the target information; and the terminal determines, based on the target information, whether to enable the wake-up signal function. The target information includes any one of following: the first information sent by the access network device or the core network device, where the first information is used to indicate to enable the wake-up signal function of the terminal; and the second information sent by an access network device, where the second information is used to indicate the type of the terminal that enables or does not enable the wake-up signal function in the terminals that access the cell corresponding to the access network device. In this way, the access network device or the core network device can enable a wake-up signal service for a part of the terminals in the cell. As a result, when a terminal that does not enable a wake-up signal function is paged, only a paging message is sent without a need to send a wake-up signal. Therefore, in the embodiments of this application, signaling overheads for paging are reduced. In addition, the network side device may selectively provide the WUS service for a terminal of a specific type, thereby reducing additional overheads caused by the network side device using a WUS.

### BRIEF DESCRIPTION OF DRAWINGS

FIG. 1 is a schematic diagram of a network structure to which an embodiment of this application is applicable;

FIG. 2 is a schematic diagram of a wake-up principle of a terminal according to this application;

FIG. 3 is a flowchart of a method for enabling a wake-up signal function according to this application;

FIG. 4 is a flowchart of another method for enabling a wake-up signal function according to this application;

FIG. 5 is a flowchart of still another method for enabling a wake-up signal function according to this application;

FIG. 6 is a schematic structural diagram of an apparatus for enabling a wake-up signal function according to this application;

FIG. 7 is a schematic structural diagram of another apparatus for enabling a wake-up signal function according to this application;

FIG. 8 is a schematic structural diagram of still another apparatus for enabling a wake-up signal function according to this application;

FIG. 9 is a schematic structural diagram of a communication device according to this application;

FIG. 10 is a structural diagram of a terminal according to this application;

FIG. 11 is a structural diagram of a network side device according to this application; and

FIG. 12 is a structural diagram of another network side device according to this application.

### DETAILED DESCRIPTION

Terms such as “first” and “second” in this application are used to distinguish between similar objects, and are unnecessarily used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” used in this application means at least one of connected objects. For example, “A or B” covers three solutions, that is, a solution 1: including A but not including B; a solution 2: including B but not including A; and a solution 3: including both A and B. The character “/” generally represents an “or” relationship between the associated objects.

The term “indication” in this application may be a direct indication (or an explicit indication) or an indirect indication (or an implicit indication). A direct indication may be understood as that, in a sent indication, a sender explicitly notifies a receiver of content such as specific information, an operation that needs to be performed, or a request result. An indirect indication may be understood as that, a receiver determines corresponding information based on an indication sent by a sender, or determines, based on a determining result, an operation that needs to be performed, a request result, or the like.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to systems other than the NR system, such as the 6^{th} Generation (6G) communication system.

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), an Augmented Reality (AR)/Virtual Reality (VR) device, a robot, a wearable device, a flight vehicle, Vehicle User Equipment (VUE), a shipboard device, Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart anklet, a smart ankle chain), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (Wi-Fi) node, or the like. The base station may be referred to as a NodeB (NB), an evolved NodeB (eNB), a next-generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a home evolved NodeB, a Transmission Reception Point (TRP), or another appropriate term in the field. As long as a same technical effect is achieved, the base station is not limited to a specified technical term. It should be noted that, in the embodiments of this application, only a base station in an NR system is used as an example, and a specific type of the base station is not limited.

The core network device may include but is not limited to at least one of following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

### 1. Low-Power Receiver

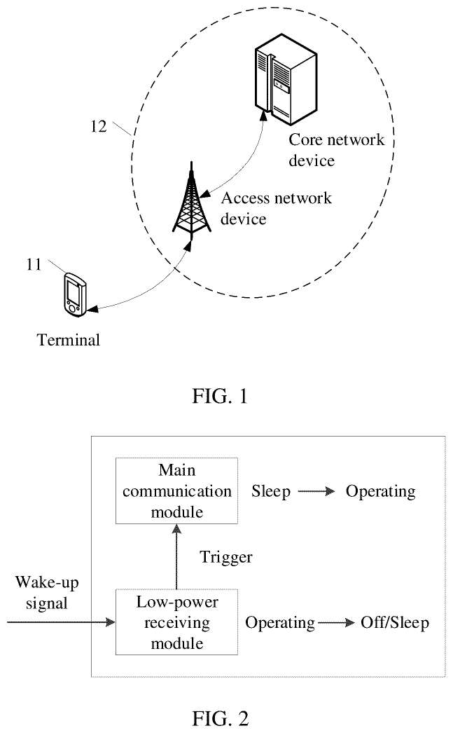

The low-power receiver may be referred to as an LP-WUR or an Almost-Zero-Power Wake-Up Receiver (AZP-WUR). A basic operating principle of the LP-WUR is as follows: A receive end includes a first module and a second module. The first module is a main communication module, and is configured to receive and send mobile communication data. The second module is a low-power receiving module (also referred to as a low-power wake-up receiving module), and is configured to receive a low-power wake-up signal. Details are shown in FIG. 2. When a terminal is in an idle state or an inactive state, the terminal turns on the low-power receiving module to monitor the LP-WUS and turns off the main communication module while in a power saving state or an ultra-deep sleep state. When downlink data arrives, a network side device sends a wake-up signal to the terminal. After monitoring and detecting the wake-up signal through the low-power receiving module, the terminal triggers the main communication module after a series of determinations to switch from an off state to an on state. In this case, the low-power receiving module enters an off state from an operating state. When turned on, the low-power wake-up receiving module can receive a low-power wake-up signal.

### 2. LP-WUS

To reduce a reception activity of a terminal in a standby state, ensure that a Radio Frequency (RF) module and a baseband (MODEM) module of a receiving module of the terminal are truly turned off, and therefore greatly reduce power consumption of communication reception, an almost-“zero”-power receiver may be introduced into the receiving module of the terminal. This almost-“zero”-power receiver does not require complex signal detection (such as amplification, filtering, and quantization) by the RF module or signal processing by the modem module, and relies solely on passive matched filtering and low-power signal processing.

On a base station side, a wake-up signal may be sent on demand to activate the almost-“zero”-power receiver to receive an activation notification, thereby triggering a series of procedures inside the terminal, for example, turning on a radio frequency transceiver module, a baseband processing module, and the like.

The wake-up signal is usually a simple On-Off Keying (OOK) signal, allowing the receiver to receive a wake-up notification through simple energy detection and a subsequent possible process, such as sequence detection and identification.

Reception of the low-power wake-up signal may be applied to a terminal in a Radio Resource Control (RRC) idle (RRC_idle)/inactive state, or may be applied to a terminal in an RRC connected (RRC_connected) state, thereby implementing power saving of the terminal.

In an embodiment, a wake-up signal mentioned in this application is the wake-up signal received and monitored by the low-power receiver, namely, the low-power wake-up signal.

In NR systems, a signal modulation scheme of Orthogonal Frequency Division Multiplex (OFDM) is commonly used. In this case, an OOK signal may be generated in a manner of generating an OFDM signal. For example, on/off in time domain may be represented by sending or not sending an OFDM-modulated sequence. The OOK signal may be received through a low-power receiver, but such a receiver has poor reception performance and coverage.

In some embodiments, an on-modulated OFDM sequence may further carry information through different sequences. For example, two sequences represent information 0 and 1, or four sequences represent information 00, 01, 10, and 11.

With reference to the accompanying drawings, the following describes in detail a method for enabling a wake-up signal function provided in the embodiments of this application by using some embodiments and application scenarios thereof.

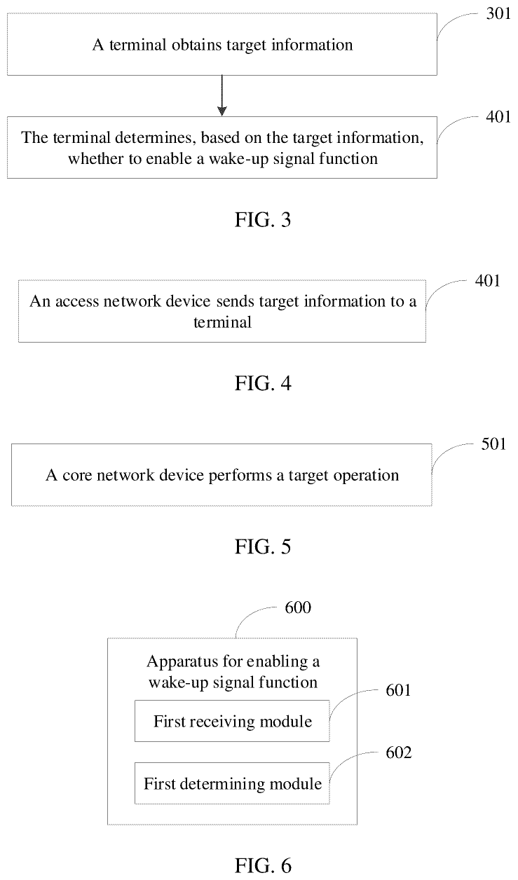

As shown in FIG. 3, an embodiment of this application provides a method for enabling a wake-up signal function. As shown in FIG. 3, the method for enabling a wake-up signal function includes:
Step 301: A terminal obtains target information.
Step 302: The terminal determines, based on the target information, whether to enable a wake-up signal function.

The target information includes any one of following:
first information sent by an access network device or a core network device, where the first information is used to indicate to enable the wake-up signal function of the terminal; and
second information sent by an access network device, where the second information is used to indicate a type of a terminal that enables or does not enable a wake-up signal function in terminals that access a cell corresponding to the access network device.

In this embodiment of the application, the first information may explicitly or implicitly indicate to enable the wake-up signal function of the terminal. For example, the first information may be indication information, and the indication information is used to directly indicate to enable the wake-up signal function of the terminal; or the first information may be configuration information of a wake-up signal, and the configuration information is used to imply that the terminal can enable the wake-up signal function.

In some embodiments, the access network device or the core network device sending the first information may be understood as the access network device or the core network device sending the first information to the terminal through dedicated signaling. The access network device may send the first information to the terminal through an RRC message, for example, may send the first information to the terminal through an RRC release (RRC_Release) message. The core network device may send the first information to the terminal through a Non-Access Stratum (NAS) message, for example, may send the first information to the terminal through a registration accept message. The first information is used to indicate to enable the wake-up signal function of the terminal. Therefore, a network side device may disable a wake-up signal service for a terminal that does not enable a wake-up signal function. As a result, when paging the terminal that does not enable a wake-up signal function, the network side device sends only a paging message without a need to send a wake-up signal, thereby reducing signaling overheads of paging.

In some embodiments, that the first information is used to indicate to enable the wake-up signal function of the terminal may be understood as or replaced with: the first information is used to indicate that the terminal can use a wake-up signal in a camped cell in a case that the terminal is in a non-connected state and the camped cell of the terminal supports a wake-up signal. The non-connected state may include an RRC idle state or an inactive state. It should be understood that in a case that the access network device or the core network device sends the first information, the camped cell of the terminal is within applicability of the first information, and the camped cell of the terminal supports the wake-up signal, the terminal may use the wake-up signal in the current camped cell.

In some embodiments, the access network device sending the second information may be understood as the access network device sending the second information to the terminal through a broadcast message. For example, the second information may be carried in a System Information Block 1 (SIB1). The second information is used to broadcast the type of the terminal that enables or does not enable the wake-up signal function. Therefore, the cell corresponding to the access network device enables a wake-up signal service only for a terminal corresponding to a part of terminal types in the terminals that access the cell corresponding to the access network device. As a result, when a network side device pages the terminal that does not enable the wake-up signal function, a network side device associated with the cell sends only a paging message without a need to send a wake-up signal, thereby reducing signaling overheads of paging.

In this embodiment of this application, the terminal obtains the target information, and the terminal determines, based on the target information, whether to enable the wake-up signal function. The target information includes any one of following: the first information sent by the access network device or the core network device, where the first information is used to indicate to enable the wake-up signal function of the terminal; and the second information sent by an access network device, where the second information is used to indicate the type of the terminal that enables or does not enable the wake-up signal function in the terminals that access the cell corresponding to the access network device. In this way, the access network device or the core network device can enable a wake-up signal service for a part of the terminals in the cell. As a result, when a terminal that does not enable a wake-up signal function is paged, only a paging message is sent without a need to send a wake-up signal. Therefore, in this embodiment of this application, signaling overheads for paging are reduced. In addition, the network side device may selectively provide the WUS service for a terminal of a type, thereby reducing additional overheads caused by the network side device using a WUS.

In some embodiments, applicability of the first information includes any one of following:
a Tracking area (TA) of the terminal;
an RAN notification area; and
a target area associated with the access network device.

In this embodiment of this application, the target area may be understood as a new area introduced by the access network device or the core network device for applicability of a WUS signal. In some embodiments, in a case that the applicability of the first information includes the target area associated with the access network device, the target information further includes indication information of the target area. In some embodiments, when the first information does not include indication information of the target area, it may be considered by default that the applicability of the first information is the tracking area of the terminal or the radio access network notification area; and when the applicability of the first information is the tracking area of the terminal or the radio access network notification area, the applicability of the first information may be agreed upon in a protocol. In some embodiments, the first information may include the tracking area of the terminal or the radio access network notification area, which is used to indicate the applicability of the first information.

In some embodiments, the second information includes any one of following:
first indication information, where the first indication information is used to indicate that the cell corresponding to the access network device sends a wake-up signal only to or only not to a terminal of a target terminal type;
second indication information, where the second indication information is used to indicate that only a terminal associated with a target terminal type enables or does not enable a wake-up signal function in the cell corresponding to the access network device; and
a first type set, where the first type set includes a type of a terminal that can enable a wake-up signal function in the cell corresponding to the access network device.

In some embodiments, in a case that the second information includes the first type set, the terminal enables the wake-up signal function in the cell corresponding to the access network device only when the type of the terminal belongs to the terminal type in the first type set.

In some embodiments, a part of cells can provide a wake-up signal service for all terminals. In this case, the second information may indicate all the terminals to enable a wake-up signal function in the cell corresponding to the access network device.

In some embodiments, in a case that the target information includes the second information, that the terminal determines, based on the target information, whether to enable a wake-up signal function includes:

The terminal determines, based on the second information and a terminal type of the terminal, whether to enable the wake-up signal function.

In this embodiment of this application, when the terminal receives the second information from the network side device, the terminal may determine, based on the second information and the terminal type of the terminal, whether to use the wake-up signal in the camped cell.

In some embodiments, before the terminal obtains the target information, the method further includes:

The terminal sends UE assistance information to a network side device, where the UE assistance information is used to determine the terminal type of the terminal, and the network side device includes at least one of the access network device and the core network device.

In this embodiment of this application, the UE assistance information is used to assist the network side device in determining the terminal type of the terminal.

In some embodiments, a manner in which the terminal reports the UE assistance information to the access network device may include at least one of following:

The terminal actively reports the UE Assistance Information (UAI);
when the network side device requests terminal capability information, the terminal reports a part or all of the UE assistance information through the terminal capability information; and
the terminal reports the UE assistance information in a random access procedure through at least one of a message 1 (msg1) and a message (msg3).

In some embodiments, a manner in which the terminal reports the UE assistance information to the core network device may include at least one of following:

The terminal reports the UE assistance information to the core network device during initial registration or mobility registration, for example, reports the UE assistance information through a registration request message or a UE configuration update complete message.

In some embodiments, the UE assistance information includes at least one of following:
the terminal type;
first capability information, where the first capability information is used to indicate whether the wake-up signal function is supported;
an access delay requirement;
a first delay, where the first delay is a switching delay for the terminal or a main receiver of the terminal to switch from an ultra-deep sleep state to a normal receiving state;
a second delay, where the second delay is a wake-up delay of the terminal or the main receiver of the terminal;
a power saving requirement; and
second capability information, where the second capability information is used to indicate whether using both a wake-up receiver WUR and a main receiver MR for measurement is supported.

In this embodiment of this application, the terminal type may include a terminal type in a related technology, such as a Reduced Capability (RedCap) terminal, and an Internet of Things (IoT) terminal, or another introduced terminal type.

The access delay requirement includes a maximum value of a time interval between time at which the terminal expects or may tolerate for data to arrive at the access network device and time at which the terminal monitors and detects paging.

In this embodiment of this application, the wake-up signal may be understood as or replaced with a low-power wake-up signal. The ultra-deep sleep state is not an RRC state, and may be understood as a very power-saving power state, or may be understood as an off state. The normal receiving state may be understood as that the terminal may perform a behavior in an RRC_idle state or an RRC_inactive state, including receiving paging, measurement and evaluation related to cell selection or reselection based on a Synchronization Signal and PBCH block (SSB), and Public Land Mobile Network (PLMN) selection, receiving system information, and the like.

In some embodiments, the terminal or the main receiver of the terminal switching from an ultra-deep sleep state to a normal receiving state may be understood as or replaced with the terminal or the main receiver of the terminal exiting the ultra-deep sleep state.

In some embodiments, the second delay may include time of turning on the main receiver, and includes time of starting the main receiver, loading a memory, and the like, for example, 400 ms or 800 ms.

In some embodiments, the power saving requirement may be understood as whether the terminal has a high power saving requirement, duration for which the terminal expects a battery of the terminal may last, or the like.

In some embodiments, the first capability information includes at least one of following:
whether a wake-up signal is supported; and
whether a Low-Power Synchronization Signal (LP-SS) is supported.

In this embodiment of this application, whether the wake-up signal is supported may be understood as or replaced with whether an almost-zero-power receiver (Almost-Zero-Power Wake-Up Signal (AZP-WUS)) is supported, or whether an AZP WUS is supported. Whether the low-power synchronization signal is supported may be understood as or replaced with whether an Almost-Zero-Power Synchronization Signal (AZP SS) is supported.

In some embodiments, the second capability information may include at least one of following:

Whether use of the WUR and the Main Receiver (MR) to receive a low power-related signal is supported;
whether use of the WUR to receive an NR channel signal is supported; and
an NR channel signal can be received only through the MR.

In this embodiment of this application, the NR channel signal may include at least one of following: an SSB, a Primary Synchronization Signal (PSS), a Secondary Synchronization Signal (SSS), a Tracking Reference Signal (TRS), and a Demodulation Reference Signal (DMRS).

In some embodiments, that the terminal sends UE assistance information to a network side device includes any one of following:

The terminal sends the UE assistance information to the access network device;
the terminal sends the UE assistance information to the core network device; and
the terminal sends one part of the UE assistance information to the access network device, and sends the other part of the UE assistance information to the core network device.

For example, in some embodiments, after the terminal reports the UE assistance information to the access network device, the access network device may determine the terminal type based on the UE assistance information. Further, the access network device may further indicate the terminal type to the core network device.

In some embodiments, after the terminal reports the UE assistance information to the access network device, the access network device may send the UE assistance information to the core network device. Further, the access network device may further receive an indication of the terminal type from the core network device.

In some embodiments, after the terminal sends the UE assistance information to the core network device, the core network device may determine the terminal type based on the UE assistance information. Further, the core network device may further indicate the terminal type to the access network device.

In some embodiments, after the terminal sends the UE assistance information to the core network device, the core network device may send the UE assistance information to the access network device. Further, the core network device may further receive an indication of the terminal type from the access network device.

In some embodiments, after the terminal sends one part of the UE assistance information to the access network device, and sends the other part of the UE assistance information to the core network device, the access network device may send the part of the UE assistance information to the core network device. The core network device integrates all UE assistance information and determines the terminal type. Further, the core network device may further indicate the terminal type to the access network device.

In some embodiments, after the terminal sends one part of the UE assistance information to the access network device, and sends the other part of the UE assistance information to the core network device, the core network device may send the other part of the UE assistance information to the access network device. The access network device integrates all UE assistance information and determines the terminal type. Further, the access network device may further indicate the terminal type to the core network device.

In some embodiments, the core network may send information to a base station through a related message, such as an initial context setting response message, a UE context modification request message, or a connection establishment indication message, a UE information transfer message, or a UE context resume response message, or a newly introduced message.

In some embodiments, the access network device may report information to the core network device through a related message, such as an initial context setting request message, a UE context modification response message, or a UE Radio Capability Match Request message, or a newly introduced message.

In some embodiments, when the terminal reports the UE assistance information to the access network, and when the access network device sends the UE assistance information to the core network device, transparent transmission may be performed, that is, the core network device does not decode the UE assistance information.

In some embodiments, the access network device may further perform the following behavior:

The access network device receives a paging message from the core network device or an anchor base station of the terminal, or the access network device sends a paging message to another access network device in a radio access network notification area of the terminal; the anchor base station of the terminal is a base station that releases a radio resource control connection of the terminal, releases the terminal into an inactive state, and stores context information of the terminal; and
the access network device determines, based on the paging message, whether to send a wake-up signal.

The paging message includes at least one of following:
UE assistance information of a paged terminal;
a terminal type of a paged terminal;
whether a paged terminal is the target terminal type; and
whether a paged terminal enables a wake-up signal function.

It should be understood that in a case that the terminal is in an inactive state and the access network device is not the anchor base station of the terminal, the access network device receives the paging message sent by the anchor base station of the terminal; in a case that the access network device is the anchor base station of the terminal, the access network device sends the paging message to the another access network device in the radio access network notification area of the terminal.

In this embodiment of this application, the access network device may determine, based on the paging message and information about whether the access network device supports the wake-up signal or whether the access network device provides the wake-up signal service for the terminal type of the terminal, whether to send the wake-up signal to the terminal.

In some embodiments, the method further includes:

The terminal receives third information in a camped cell, where the third information is used to indicate whether a frequency or a cell associated with a neighboring cell enables a wake-up signal function for a terminal associated with the target terminal type.

It should be understood that, in this embodiment of this application, in a case that the camped cell of the terminal supports the wake-up signal, the camped cell may send the third information to the terminal. The third information includes one or more pieces of indication information. In some embodiments, each piece of indication information is 1 bit, and each frequency in a System Information Block 4 (SIB4) corresponds to one piece of indication information; or each carrier frequency or a newly introduced LP-SS frequency in a System Information Block 5 (SIB5) corresponds to one piece of indication information. In some embodiments, the indication information may be a sequence having a same length as that of frequency information in the SIB4, or a sequence having a same length as that of carrier frequency information in the SIB5, or a sequence having a same length as that of the newly introduced LP-SS frequency information, where each piece of indication information in the sequence corresponds to a frequency or carrier frequency at a same bit location.

In this embodiment of this application, the third information is used to indicate whether the frequency or cell associated with the neighboring cell enables the wake-up signal function for the terminal associated with the target terminal type. In this way, the terminal may reselect to a cell that enables the WUS function for the terminal.

As shown in FIG. 4, an embodiment of this application further provides a method for enabling a wake-up signal function. As shown in FIG. 4, the method for enabling a wake-up signal function includes:
Step 401: An access network device sends target information to a terminal.

The target information includes any one of following:
first information, where the first information is used to indicate to enable a wake-up signal function of the terminal; and
second information, where the second information is used to indicate a type of a terminal that enables or does not enable a wake-up signal function in terminals that access a cell corresponding to the access network device.

In some embodiments, applicability of the first information includes any one of following:
a tracking area of the terminal;
a radio access network notification area; and
a target area associated with the access network device.

In some embodiments, in a case that the applicability of the first information includes the target area associated with the access network device, the target information further includes indication information of the target area.

In some embodiments, the second information includes any one of following:
first indication information, where the first indication information is used to indicate that the cell corresponding to the access network device sends a wake-up signal only to or only not to a terminal of a target terminal type;
second indication information, where the second indication information is used to indicate that only the terminal of the target terminal type enables or does not enable a wake-up signal function in the cell corresponding to the access network device; and
a first type set, where the first type set includes a type of a terminal that can enable a wake-up signal function in the cell corresponding to the access network device.

In some embodiments, before the access network device sends the target information to the terminal, the method further includes:

The access network device receives fourth information from a core network device, where the fourth information is used to determine the second information, and the fourth information includes any one of following:
third indication information, where the third indication information is used to indicate that the core network device enables a wake-up signal function only for or only not for a terminal of a target terminal type;
fourth indication information, where the fourth indication information is used to indicate that only the terminal associated with the target terminal type enables or does not enable the wake-up signal function in a case of accessing the core network device; and
a second type set, where the second type set includes a type of a terminal that can enable a wake-up signal function in a case of accessing the core network device.

In some embodiments, the method further includes:

In a case that the target information includes the first information, the access network device obtains a terminal type of the terminal.

That an access network device sends target information to a terminal includes: In a case that the terminal type of the terminal is a target terminal type, the access network device sends the first information to the terminal.

In some embodiments, that the access network device obtains a terminal type of the terminal includes any one of following:

The access network device obtains UE assistance information, and determines the terminal type of the terminal based on the UE assistance information; and
the access network device receives fifth indication information from a core network device, where the fifth indication information is used to indicate the terminal type of the terminal.

In some embodiments, that the access network device obtains UE assistance information includes any one of following:

The access network device receives the UE assistance information from the core network device or the terminal; and
the access network device receives a part of the UE assistance information from the terminal, and receives the other part of the UE assistance information from the core network device.

In some embodiments, before the access network device receives the fifth indication information from the core network device, the method further includes:

The access network device receives at least a part of the UE assistance information from the terminal; and
the access network device sends the at least a part of the UE assistance information to the core network device.

In some embodiments, the UE assistance information includes at least one of following:
the terminal type;
first capability information, where the first capability information is used to indicate whether the wake-up signal function is supported;
an access delay requirement;
a first delay, where the first delay is a switching delay for the terminal or a main receiver of the terminal to switch from an ultra-deep sleep state to a normal receiving state;
a second delay, where the second delay is a wake-up delay of the terminal or the main receiver of the terminal;
a power saving requirement; and
second capability information, where the second capability information is used to indicate whether using both a wake-up receiver WUR and a main receiver MR for measurement is supported.

In some embodiments, the first capability information includes at least one of following:
whether a wake-up signal is supported; and
whether a low-power synchronization signal is supported.

In some embodiments, the method further includes:

The access network device sends third information to the terminal, where the third information is used to indicate whether a frequency or a cell associated with a neighboring cell enables a wake-up signal function for a terminal associated with the target terminal type.

In some embodiments, the method further includes:

The access network device receives a paging message from the core network device or an anchor base station of the terminal, or the access network device sends a paging message to another access network device in a radio access network notification area of the terminal; and
the access network device determines, based on the paging message, whether to send a wake-up signal.

The paging message includes at least one of following:
UE assistance information of a paged terminal;
a terminal type of a paged terminal;
whether a paged terminal is the target terminal type; and
whether a paged terminal enables a wake-up signal function.

In some embodiments, the target terminal type meets at least one of following:

The wake-up signal function is supported;
an access delay is greater than or equal to first preset duration, or an access delay is equal to first preset duration, or an access delay is less than or equal to first preset duration;
a first delay is greater than or equal to second preset duration, or a first delay is equal to second preset duration, or a first delay is less than or equal to second preset duration;
a second delay is greater than or equal to third preset duration, or a second delay is equal to third preset duration, or a second delay is less than or equal to third preset duration;
a power saving requirement is greater than or equal to a preset threshold; and
using both a WUR and an MR for measurement is supported.

The first delay is a switching delay of the terminal or the main receiver of the terminal to switch from an ultra-deep sleep state to a normal receiving state, and the second delay is a wake-up delay of the terminal or the main receiver of the terminal.

As shown in FIG. 5, an embodiment of this application further provides a method for enabling a wake-up signal function. As shown in FIG. 5, the method for enabling a wake-up signal function includes:
Step 501: A core network device performs a target operation.

The target operation includes any one of following:
sending first information to a terminal; and
sending fourth information to an access network device, where the fourth information is used to assist the access network device in sending second information to the terminal.

The first information is used to indicate to enable the wake-up signal function of the terminal, and the second information is used to indicate a type of a terminal that enables or does not enable a wake-up signal function in terminals that access a cell corresponding to the access network device.

In some embodiments, applicability of the first information includes any one of following:
a tracking area of the terminal;
a radio access network notification area; and
a target area associated with the access network device.

In some embodiments, in a case that the applicability of the first information includes the target area associated with the access network device, the method further includes:

The core network device sends the target area to the terminal.

In some embodiments, the second information includes any one of following:
first indication information, where the first indication information is used to indicate that the cell corresponding to the access network device sends a wake-up signal only to or only not to a terminal of a target terminal type;
second indication information, where the second indication information is used to indicate that only the terminal of the target terminal type enables or does not enable a wake-up signal function in the cell corresponding to the access network device; and
a first type set, where the first type set includes a type of a terminal that can enable a wake-up signal function in the cell corresponding to the access network device.

In some embodiments, the fourth information includes any one of following:
third indication information, where the third indication information is used to indicate that the core network device enables a wake-up signal function only for or only not for a terminal of a target terminal type;
fourth indication information, where the fourth indication information is used to indicate that only the terminal of the target terminal type enables or does not enable the wake-up signal function in a case of accessing the core network device; and
a second type set, where the second type set includes a type of a terminal that can enable a wake-up signal function in a case of accessing the core network device.

In some embodiments, in a case that the target operation includes sending the first information to the terminal, that a core network device performs a target operation includes:

The core network device obtains a terminal type of the terminal; and
in a case that the terminal type of the terminal is a target terminal type, the core network device sends the first information to the terminal.

In some embodiments, that the core network device obtains a terminal type of the terminal includes any one of following:

The core network device obtains UE assistance information, and determines the terminal type of the terminal based on the UE assistance information; and
the core network device receives sixth indication information from the access network device, where the sixth indication information is used to indicate the terminal type of the terminal.

In some embodiments, that the core network device obtains UE assistance information includes at least one of following:

The core network device receives the UE assistance information from the access network device or the terminal; and
the core network device receives a part of the UE assistance information from the terminal, and receives the other part of the UE assistance information from the access network device.

In some embodiments, before the core network device receives the sixth indication information from the access network device, the method further includes:

The core network device receives at least a part of the UE assistance information from the terminal; and
the core network device sends the at least one part of the UE assistance information to the access network device.

In some embodiments, the UE assistance information includes at least one of following:
the terminal type;
first capability information, where the first capability information is used to indicate whether the wake-up signal function is supported;
an access delay requirement;
a first delay, where the first delay is a switching delay for the terminal or a main receiver of the terminal to switch from an ultra-deep sleep state to a normal receiving state;
a second delay, where the second delay is a wake-up delay of the terminal or the main receiver of the terminal;
a power saving requirement; and
second capability information, where the second capability information is used to indicate whether using both a wake-up receiver WUR and a main receiver MR for measurement is supported.

In some embodiments, the first capability information includes at least one of following:
whether a wake-up signal is supported; and
whether a low-power synchronization signal is supported.

In some embodiments, the method further includes:

The core network device sends a paging message to the access network device.

The paging message is used to determine whether to send a wake-up signal, and the paging message includes at least one of following:
UE assistance information of a paged terminal;
a terminal type of a paged terminal;
whether a paged terminal is the target terminal type; and
whether a paged terminal enables a wake-up signal function.

In some embodiments, the target terminal type meets at least one of following:

The wake-up signal function is supported;
an access delay is greater than or equal to first preset duration, or an access delay is equal to first preset duration, or an access delay is less than or equal to first preset duration;
a first delay is greater than or equal to second preset duration, or a first delay is equal to second preset duration, or a first delay is less than or equal to second preset duration;
a second delay is greater than or equal to third preset duration, or a second delay is equal to third preset duration, or a second delay is less than or equal to third preset duration;
a power saving capability is greater than or equal to a preset threshold; and
using both a WUR and an MR for measurement is supported.

The first delay is a switching delay of the terminal or the main receiver of the terminal to switch from an ultra-deep sleep state to a normal receiving state, and the second delay is a wake-up delay of the terminal or the main receiver of the terminal.

The methods for enabling a wake-up signal function provided in this embodiment of this application may be performed by an apparatus for enabling a wake-up signal function. An apparatus for enabling a wake-up signal function provided in an embodiment of this application is described by using an example in which the apparatus for enabling a wake-up signal function performs the methods for enabling a wake-up signal function according to embodiments of this application.

As shown in FIG. 6, an embodiment of this application further provides an apparatus for enabling a wake-up signal function. As shown in FIG. 6, the apparatus 600 for enabling a wake-up signal function includes:
a first receiving module 601, configured to obtain target information; and
a first determining module 602, configured to determine, based on the target information, whether to enable a wake-up signal function.

The target information includes any one of following:
first information sent by an access network device or a core network device, where the first information is used to indicate to enable a wake-up signal function of a terminal; and
second information sent by an access network device, where the second information is used to indicate a type of a terminal that enables or does not enable a wake-up signal function in terminals that access a cell corresponding to the access network device.

In some embodiments, applicability of the first information includes any one of following:
a tracking area of the terminal;
a radio access network notification area; and
a target area associated with the access network device.

In some embodiments, in a case that the applicability of the first information includes the target area associated with the access network device, the target information further includes indication information of the target area.

In some embodiments, the second information includes any one of following:
first indication information, where the first indication information is used to indicate that the cell corresponding to the access network device sends a wake-up signal only to or only not to a terminal of a target terminal type;
second indication information, where the second indication information is used to indicate that only the terminal of the target terminal type enables or does not enable a wake-up signal function in the cell corresponding to the access network device; and
a first type set, where the first type set includes a type of a terminal that can enable a wake-up signal function in the cell corresponding to the access network device.

In some embodiments, the first determining module 602 is further configured to: in a case that the target information includes the second information, determine, based on the second information and a terminal type of the terminal, whether to enable the wake-up signal function.

In some embodiments, the apparatus 600 for enabling a wake-up signal function further includes:
a first sending module, configured to send UE assistance information to a network side device, where the UE assistance information is used to determine the terminal type of the terminal, and the network side device includes at least one of the access network device and the core network device.

In some embodiments, the UE assistance information includes at least one of following:
the terminal type;
first capability information, where the first capability information is used to indicate whether the wake-up signal function is supported;
an access delay requirement;
a first delay, where the first delay is a switching delay for the terminal or a main receiver of the terminal to switch from an ultra-deep sleep state to a normal receiving state;
a second delay, where the second delay is a wake-up delay of the terminal or the main receiver of the terminal;
a power saving requirement; and
second capability information, where the second capability information is used to indicate whether using both a wake-up receiver WUR and a main receiver MR for measurement is supported.

In some embodiments, the first capability information includes at least one of following:
whether a wake-up signal is supported; and
whether a low-power synchronization signal is supported.

In some embodiments, the first sending module is configured to perform any one of following:
sending the UE assistance information to the access network device;
sending the UE assistance information to the core network device; and
sending one part of the UE assistance information to the access network device, and sending the other part of the UE assistance information to the core network device.

In some embodiments, the first receiving module 601 is further configured to receive third information in a camped cell, where the third information is used to indicate whether a frequency or a cell associated with a neighboring cell enables a wake-up signal function for a terminal associated with the target terminal type.

In some embodiments, the target terminal type meets at least one of following:

The wake-up signal function is supported;
an access delay is greater than or equal to first preset duration, or an access delay is equal to first preset duration, or an access delay is less than or equal to first preset duration;
a first delay is greater than or equal to second preset duration, or a first delay is equal to second preset duration, or a first delay is less than or equal to second preset duration;
a second delay is greater than or equal to third preset duration, or a second delay is equal to third preset duration, or a second delay is less than or equal to third preset duration;
a power saving requirement is greater than or equal to a preset threshold; and
using both a WUR and an MR for measurement is supported.

The first delay is a switching delay of the terminal or the main receiver of the terminal to switch from an ultra-deep sleep state to a normal receiving state, and the second delay is a wake-up delay of the terminal or the main receiver of the terminal.

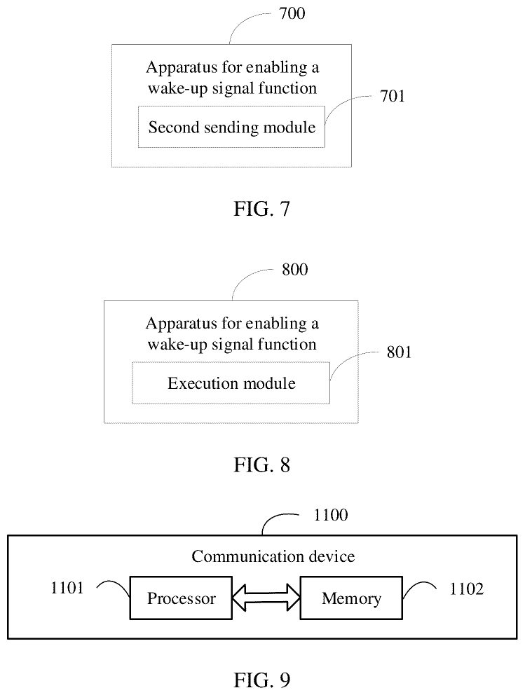

As shown in FIG. 7, an embodiment of this application further provides an apparatus for enabling a wake-up signal function. As shown in FIG. 7, the apparatus 700 for enabling a wake-up signal function includes:
a second sending module 701, configured to send target information to a terminal.

The target information includes any one of following:
first information, where the first information is used to indicate to enable a wake-up signal function of a terminal; and
second information, where the second information is used to indicate a type of a terminal that enables or does not enable a wake-up signal function in terminals that access a cell corresponding to an access network device.

In some embodiments, applicability of the first information includes any one of following:
a tracking area of the terminal;
a radio access network notification area; and
a target area associated with the access network device.

In some embodiments, in a case that the applicability of the first information includes the target area associated with the access network device, the target information further includes indication information of the target area.

In some embodiments, the second information includes any one of following:
first indication information, where the first indication information is used to indicate that the cell corresponding to the access network device sends a wake-up signal only to or only not to a terminal of a target terminal type;
second indication information, where the second indication information is used to indicate that only the terminal of the target terminal type enables or does not enable a wake-up signal function in the cell corresponding to the access network device; and
a first type set, where the first type set includes a type of a terminal that can enable a wake-up signal function in the cell corresponding to the access network device.

In some embodiments, the apparatus for enabling a wake-up signal function further includes:
a second receiving module, configured to receive fourth information from a core network device, where the fourth information is used to determine the second information, and the fourth information includes any one of following:
third indication information, where the third indication information is used to indicate that the core network device enables a wake-up signal function only for or only not for a terminal of a target terminal type;
fourth indication information, where the fourth indication information is used to indicate that only the terminal of the target terminal type enables or does not enable the wake-up signal function in a case of accessing the core network device; and
a second type set, where the second type set includes a type of a terminal that can enable a wake-up signal function in a case of accessing the core network device.

In some embodiments, the apparatus for enabling a wake-up signal function further includes:
a second receiving module, configured to: in a case that the target information includes the first information, obtain a terminal type of the terminal.

The second sending module 701 is configured to: in a case that the terminal type of the terminal is a target terminal type, send the first information to the terminal.

In some embodiments, the second receiving module is configured to perform any one of following:
obtaining UE assistance information, and determining the terminal type of the terminal based on the UE assistance information; and
receiving fifth indication information from a core network device, where the fifth indication information is used to indicate the terminal type of the terminal.

In some embodiments, the second receiving module is configured to perform any one of following:
receiving the UE assistance information from the core network device or the terminal; and
receiving a part of the UE assistance information from the terminal, and receiving the other part of the UE assistance information from the core network device.

In some embodiments, the second receiving module is further configured to receive at least a part of the UE assistance information from the terminal; and
the second sending module 701 is further configured to send the at least a part of the UE assistance information to the core network device.

In some embodiments, the UE assistance information includes at least one of following:
the terminal type;
first capability information, where the first capability information is used to indicate whether the wake-up signal function is supported;
an access delay requirement;
a first delay, where the first delay is a switching delay for the terminal or a main receiver of the terminal to switch from an ultra-deep sleep state to a normal receiving state;
a second delay, where the second delay is a wake-up delay of the terminal or the main receiver of the terminal;
a power saving requirement; and
second capability information, where the second capability information is used to indicate whether using both a wake-up receiver WUR and a main receiver MR for measurement is supported.

In some embodiments, the first capability information includes at least one of following:
whether a wake-up signal is supported; and
whether a low-power synchronization signal is supported.

In some embodiments, the method further includes:

The access network device sends third information to the terminal, where the third information is used to indicate whether a frequency or a cell associated with a neighboring cell enables a wake-up signal function for a terminal associated with the target terminal type.

In some embodiments, the apparatus 700 for enabling a wake-up signal function further includes:
a second receiving module, configured to: receive a paging message from the core network device or an anchor base station of the terminal, or send a paging message to another access network device in a radio access network notification area of the terminal; and
a second determining module, configured to determine, based on the paging message, whether to send a wake-up signal.

The paging message includes at least one of following:
UE assistance information of a paged terminal;
a terminal type of a paged terminal;
whether a paged terminal is the target terminal type; and
whether a paged terminal enables a wake-up signal function.

In some embodiments, the target terminal type meets at least one of following:

The wake-up signal function is supported;
an access delay is greater than or equal to first preset duration, or an access delay is equal to first preset duration, or an access delay is less than or equal to first preset duration;
a first delay is greater than or equal to second preset duration, or a first delay is equal to second preset duration, or a first delay is less than or equal to second preset duration;
a second delay is greater than or equal to third preset duration, or a second delay is equal to third preset duration, or a second delay is less than or equal to third preset duration;
a power saving requirement is greater than or equal to a preset threshold; and
using both a WUR and an MR for measurement is supported.

The first delay is a switching delay of the terminal or the main receiver of the terminal to switch from an ultra-deep sleep state to a normal receiving state, and the second delay is a wake-up delay of the terminal or the main receiver of the terminal.

As shown in FIG. 8, an embodiment of this application further provides an apparatus for enabling a wake-up signal function. As shown in FIG. 8, the apparatus 800 for enabling a wake-up signal function includes:
an execution module 801, configured to perform a target operation.

The target operation includes any one of following:
sending first information to a terminal; and
sending fourth information to an access network device, where the fourth information is used to assist the access network device in sending second information to the terminal.

The first information is used to indicate to enable the wake-up signal function of the terminal, and the second information is used to indicate a type of a terminal that enables or does not enable a wake-up signal function in terminals that access a cell corresponding to the access network device.

In some embodiments, applicability of the first information includes any one of following:
a tracking area of the terminal;
a radio access network notification area; and
a target area associated with the access network device.

In some embodiments, in a case that the applicability of the first information includes the target area associated with the access network device, the execution module 801 is further configured to send the target area to the terminal.

In some embodiments, the second information includes any one of following:
first indication information, where the first indication information is used to indicate that the cell corresponding to the access network device sends a wake-up signal only to or only not to a terminal of a target terminal type;
second indication information, where the second indication information is used to indicate that only the terminal of the target terminal type enables or does not enable a wake-up signal function in the cell corresponding to the access network device; and
a first type set, where the first type set includes a type of a terminal that can enable a wake-up signal function in the cell corresponding to the access network device.

In some embodiments, the fourth information includes any one of following:
third indication information, where the third indication information is used to indicate that the core network device enables a wake-up signal function only for or only not for a terminal of a target terminal type;
fourth indication information, where the fourth indication information is used to indicate that only the terminal of the target terminal type enables or does not enable the wake-up signal function in a case of accessing the core network device; and
a second type set, where the second type set includes a type of a terminal that can enable a wake-up signal function in a case of accessing the core network device.

In some embodiments, the execution module 801 is configured to: in a case that the target operation includes sending the first information to the terminal, obtain a terminal type of a terminal; and in a case that the terminal type of the terminal is a target terminal type, send the first information to the terminal.

In some embodiments, the execution module 801 is configured to:
obtain UE assistance information, and determine the terminal type of the terminal based on the UE assistance information; and
receive sixth indication information from the access network device, where the sixth indication information is used to indicate the terminal type of the terminal.

In some embodiments, the execution module 801 is configured to perform at least one of following:
receiving the UE assistance information from the access network device or the terminal; and
receiving a part of the UE assistance information from the terminal, and receiving the other part of the UE assistance information from the access network device.

In some embodiments, the execution module 801 is further configured to:
receive at least a part of the UE assistance information from the terminal; and
send the at least the part of information of the UE assistance information to the access network device.

In some embodiments, the UE assistance information includes at least one of following:
the terminal type;
first capability information, where the first capability information is used to indicate whether the wake-up signal function is supported;
an access delay requirement;
a first delay, where the first delay is a switching delay for the terminal or a main receiver of the terminal to switch from an ultra-deep sleep state to a normal receiving state;
a second delay, where the second delay is a wake-up delay of the terminal or the main receiver of the terminal;
a power saving requirement; and
second capability information, where the second capability information is used to indicate whether using both a wake-up receiver WUR and a main receiver MR for measurement is supported.

In some embodiments, the first capability information includes at least one of following:
whether a wake-up signal is supported; and
whether a low-power synchronization signal is supported.

In some embodiments, the method further includes:

The core network device sends a paging message to the access network device.

The paging message is used to determine whether to send a wake-up signal, and the paging message includes at least one of following:
UE assistance information of a paged terminal;
a terminal type of a paged terminal;
whether a paged terminal is the target terminal type; and
whether a paged terminal enables a wake-up signal function.

In some embodiments, the target terminal type meets at least one of following:

The wake-up signal function is supported;
an access delay is greater than or equal to first preset duration, or an access delay is equal to first preset duration, or an access delay is less than or equal to first preset duration;
a first delay is greater than or equal to second preset duration, or a first delay is equal to second preset duration, or a first delay is less than or equal to second preset duration;
a second delay is greater than or equal to third preset duration, or a second delay is equal to third preset duration, or a second delay is less than or equal to third preset duration;
a power saving capability is greater than or equal to a preset threshold; and
using both a WUR and an MR for measurement is supported.

The first delay is a switching delay of the terminal or the main receiver of the terminal to switch from an ultra-deep sleep state to a normal receiving state, and the second delay is a wake-up delay of the terminal or the main receiver of the terminal.

The apparatus for enabling a wake-up signal function in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing enumerated types of the terminal 11, and the another device may be a server, a network attached storage, or the like. This is not limited in this embodiment of this application.

The apparatus for enabling a wake-up signal function provided in this embodiment of this application can implement the processes of the method embodiments in FIG. 3 to FIG. 5, with same technical effect achieved. To avoid repetition, details are not described herein again.

As shown in FIG. 9, an embodiment of this application further provides a communication device 900, including a processor 901 and a memory 902. The memory 902 stores a program or an instruction that can be run on the processor 901, and the program or the instruction is executed by the processor 901 to implement the steps of the foregoing embodiments of the methods for enabling a wake-up signal function, and a same technical effect can be achieved. To avoid repetition, details are not described herein again.

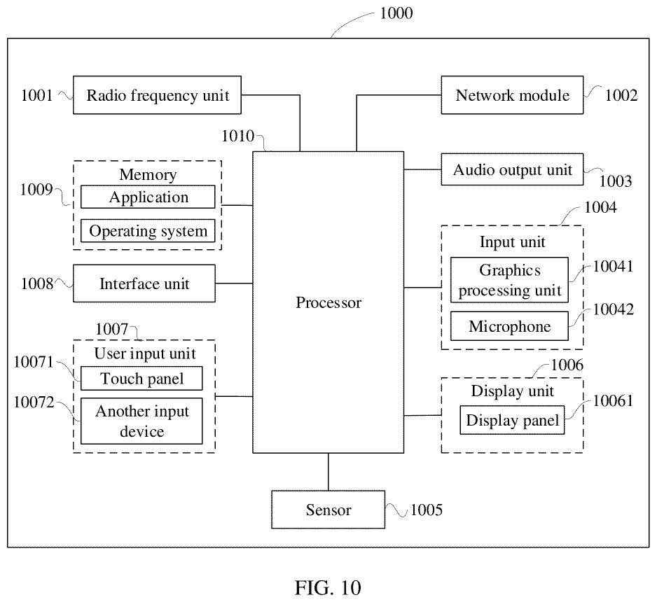

An embodiment of this application further provides a terminal, including a processor and a communication interface, where the communication interface is coupled to the processor, and the processor is used to run a program or an instruction, to implement the steps of the method embodiment shown in FIG. 3. The terminal embodiment corresponds to the method embodiments on the terminal side, each implementation process and implementation of the method embodiments can be applied to the terminal embodiment, and a same technical effect can be achieved. For example, FIG. 10 is a schematic diagram of a hardware structure of a terminal according to an embodiment of this application.

The terminal 1000 includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 through a power supply management system, to implement functions such as charging and discharging management, and power consumption management through the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may include a volatile memory or a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1009 in this embodiment of this application includes but is not limited to these memories and any memory of another proper type.

The processor 1010 may include one or more processing units. In some embodiments, an application processor and a modem processor are integrated into the processor 1010. The application processor mainly processes an operating system, a user interface, an application, or the like. The modem processor mainly processes a wireless communication signal, for example, a baseband processor. It may be understood that the modem processor may not be integrated into the processor 1010.

The radio frequency unit 1001 is configured to obtain target information.

The processor 1010 is configured to determine, based on the target information, whether to enable a wake-up signal function.

The target information includes any one of following:
first information sent by an access network device or a core network device, where the first information is used to indicate to enable the wake-up signal function of the terminal; and
second information sent by an access network device, where the second information is used to indicate a type of a terminal that enables or does not enable a wake-up signal function in terminals that access a cell corresponding to the access network device.

It may be understood that, for an implementation process of the implementations of the embodiments, reference may be made to the related descriptions in the foregoing embodiments of the methods on the terminal side, and a same or corresponding technical effect is achieved. To avoid repetition, details are not described herein again.

An embodiment of this application further provides a network side device, including a processor and a communication interface, where the communication interface is coupled to the processor, and the processor is used to run a program or an instruction, to implement the steps of the method embodiment shown in FIG. 4 or FIG. 5. This network side device embodiment corresponds to the foregoing method embodiments of the network side device. Each implementation process and implementation of the foregoing method embodiments is applicable to this network side device embodiment, and a same technical effect can be achieved.

For example, an embodiment of this application further provides a network side device. As shown in FIG. 11, the network side device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes information to be sent, and sends processed information to the radio frequency apparatus 112. The radio frequency apparatus 112 processes the received information, and sends processed information through the antenna 111.

In the foregoing embodiment, the methods performed by the network side device may be implemented in the baseband apparatus 113. The baseband apparatus 113 includes a baseband processor.

For example, the baseband apparatus 113 may include at least one baseband board. A plurality of chips are disposed on the baseband board. As shown in FIG. 11, one chip is, for example, a baseband processor, and is connected to the memory 115 through a bus interface, to invoke a program in the memory 115 to perform the operations of the network device shown in the foregoing method embodiments.

The network side device may further include a network interface 116, and the interface is, for example, a common public radio interface (Common Public Radio Interface, CPRI).

For example, the network side device 1100 in this embodiment of this application further includes an instruction or a program stored in the memory 115 and capable of running on the processor 114. The processor 114 invokes the instruction or program in the memory 115 to perform the method performed by the modules shown in FIG. 7, and a same technical effect can be achieved. To avoid repetition, details are not described herein again.

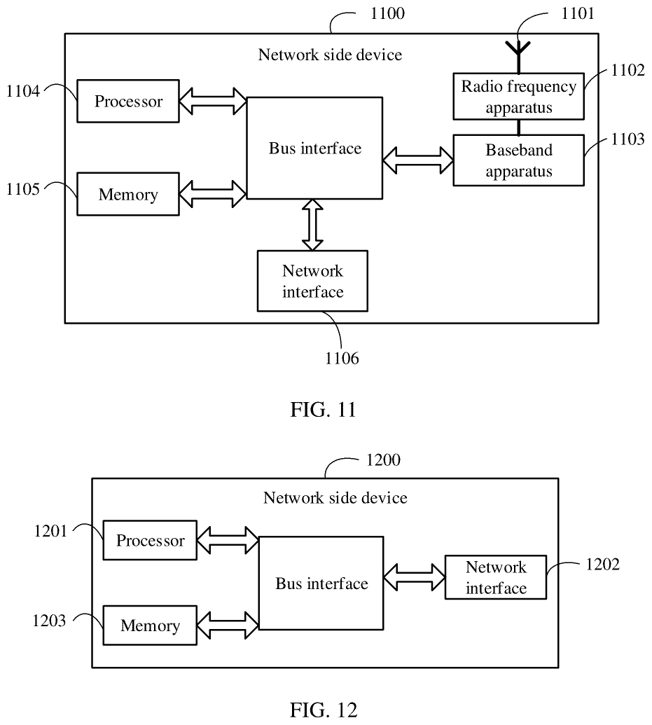

For example, an embodiment of this application further provides a network side device. As shown in FIG. 12, a network side device 1200 includes a processor 1201, a network interface 1202, and a memory 1203. The network interface 1202 is, for example, a Common Public Radio Interface (CPRI).

For example, the network side device 1200 in this embodiment of this application further includes an instruction or a program stored in the memory 1203 and capable of running on the processor 1201. The processor 1201 invokes the instruction or program in the memory 1203 to perform the method performed by the modules shown in FIG. 8, and a same technical effect can be achieved. To avoid repetition, details are not described herein again.

An embodiment of this application further provides a readable storage medium. The readable storage medium stores a program or an instruction, and the program or the instruction is executed by a processor to implement the processes of the foregoing embodiments of the methods for enabling a wake-up signal function, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface, the communication interface is coupled to the processor, and the processor is configured to run a program or an instruction to implement the processes of the foregoing embodiments of the methods for enabling a wake-up signal function, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement processes of the foregoing embodiments of the methods for enabling a wake-up signal function, and a same technical effect can be achieved. To avoid repetition, details are not described herein again.

An embodiment of this application further provides a wireless communication system, including a terminal and a network side device. The terminal may be configured to perform the steps of the foregoing methods for enabling a wake-up signal function on a terminal side, and the network side device may be configured to perform the steps of the foregoing methods for enabling a wake-up signal function on an access network device side or a core network device side.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the foregoing method embodiments may be implemented by using a computer software product; and software in addition to a necessary universal hardware platform or by hardware only. The computer software product is stored in a storage medium (such as a ROM, a RAM, a magnetic disk, or an optical disc) and includes several instructions for instructing the terminal or the network side device to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make implementations in many forms without departing from the purpose of this application and the protection scope of the claims, all of which fall within the protection of this application.

1. A method for enabling a wake-up signal function, comprising:
obtaining, by a terminal, target information; and
determining, by the terminal based on the target information, whether to enable the wake-up signal function, wherein
the target information comprises any one of following:
first information sent by an access network device or a core network device, wherein the first information is used to indicate to enable the wake-up signal function of the terminal; or
second information sent by an access network device, wherein the second information is used to indicate a type of a terminal that enables or does not enable a wake-up signal function in terminals that access a cell corresponding to the access network device.

2. The method according to claim 1, wherein applicability of the first information comprises any one of following:
a tracking area of the terminal;
a radio access network notification area; or
a target area associated with the access network device.

3. The method according to claim 1, wherein the second information comprises any one of following:
first indication information, wherein the first indication information is used to indicate that the cell corresponding to the access network device sends a wake-up signal only to or only not to a terminal of a target terminal type;
second indication information, wherein the second indication information is used to indicate that only the terminal of the target terminal type enables or does not enable a wake-up signal function in the cell corresponding to the access network device; or
information of a first type set, wherein the first type set comprises a type of a terminal that is capable of enabling a wake-up signal function in the cell corresponding to the access network device.

4. The method according to claim 1, wherein before the obtaining, by a terminal, target information, the method further comprises:
sending, by the terminal, UE assistance information to a network side device, wherein the UE assistance information is used to determine the terminal type of the terminal, and the network side device comprises at least one of the access network device or the core network device.

5. The method according to claim 4, wherein the UE assistance information comprises at least one of following:
the terminal type;
first capability information, wherein the first capability information is used to indicate whether the wake-up signal function is supported;
an access delay requirement;
a first delay, wherein the first delay is a switching delay for the terminal or a main receiver of the terminal to switch from an ultra-deep sleep state to a normal receiving state;
a second delay, wherein the second delay is a wake-up delay of the terminal or the main receiver of the terminal;
a power saving requirement; or
second capability information, wherein the second capability information is used to indicate whether using both a Wake-Up Receiver (WUR) and a Main Receiver (MR) for measurement is supported.

6. The method according to claim 3, wherein the target terminal type meets at least one of following:
the wake-up signal function is supported;
an access delay is greater than or equal to first preset duration, or an access delay is equal to first preset duration, or an access delay is less than or equal to first preset duration;
a first delay is greater than or equal to second preset duration, or a first delay is equal to second preset duration, or a first delay is less than or equal to second preset duration;
a second delay is greater than or equal to third preset duration, or a second delay is equal to third preset duration, or a second delay is less than or equal to third preset duration;
a power saving requirement is greater than or equal to a preset threshold; or
using both a WUR and an MR for measurement is supported, wherein
the first delay is a switching delay of the terminal or the main receiver of the terminal to switch from an ultra-deep sleep state to a normal receiving state, and the second delay is a wake-up delay of the terminal or the main receiver of the terminal.

7. A method for enabling a wake-up signal function, comprising:
sending, by an access network device, target information to a terminal, wherein
the target information comprises any one of following:
first information, wherein the first information is used to indicate to enable a wake-up signal function of the terminal; or
second information, wherein the second information is used to indicate a type of a terminal that enables or does not enable a wake-up signal function in terminals that access a cell corresponding to the access network device.

8. The method according to claim 7, wherein the second information comprises any one of following:
first indication information, wherein the first indication information is used to indicate that the cell corresponding to the access network device sends a wake-up signal only to or only not to a terminal of a target terminal type;
second indication information, wherein the second indication information is used to indicate that only the terminal of the target terminal type enables or does not enable a wake-up signal function in the cell corresponding to the access network device; or
information of a first type set, wherein the first type set comprises a type of a terminal that is capable of enabling a wake-up signal function in the cell corresponding to the access network device.

9. The method according to claim 7, further comprising:
when the target information comprises the first information, obtaining, by the access network device, a terminal type of the terminal, wherein
the sending, by an access network device, target information to a terminal comprises: when the terminal type of the terminal is a target terminal type, sending, by the access network device, the first information to the terminal.

10. The method according to claim 9, wherein the obtaining, by the access network device, a terminal type of the terminal comprises any one of following:
obtaining, by the access network device, UE assistance information, and determining the terminal type of the terminal based on the UE assistance information; or
receiving, by the access network device, fifth indication information from a core network device, wherein the fifth indication information is used to indicate the terminal type of the terminal.

11. The method according to claim 10, wherein the UE assistance information comprises at least one of following:
the terminal type;
first capability information, wherein the first capability information is used to indicate whether the wake-up signal function is supported;
an access delay requirement;
a first delay, wherein the first delay is a switching delay for the terminal or a main receiver of the terminal to switch from an ultra-deep sleep state to a normal receiving state;
a second delay, wherein the second delay is a wake-up delay of the terminal or the main receiver of the terminal;
a power saving requirement; or
second capability information, wherein the second capability information is used to indicate whether using both a Wake-Up Receiver (WUR) and a Main Receiver (MR) for measurement is supported.

12. The method according to claim 7, further comprising:
receiving, by the access network device, a paging message from the core network device or an anchor base station of the terminal, or sending, by the access network device, a paging message to another access network device in a radio access network notification area of the terminal; and
determining, by the access network device based on the paging message, whether to send a wake-up signal, wherein
the paging message comprises at least one of following:
UE assistance information of a paged terminal;
a terminal type of a paged terminal;
whether a paged terminal is the target terminal type; or
whether a paged terminal enables a wake-up signal function.

13. The method according to claim 8, wherein the target terminal type meets at least one of following:
the wake-up signal function is supported;
an access delay is greater than or equal to first preset duration, or an access delay is equal to first preset duration, or an access delay is less than or equal to first preset duration;
a first delay is greater than or equal to second preset duration, or a first delay is equal to second preset duration, or a first delay is less than or equal to second preset duration;
a second delay is greater than or equal to third preset duration, or a second delay is equal to third preset duration, or a second delay is less than or equal to third preset duration;
a power saving requirement is greater than or equal to a preset threshold; or
using both a WUR and an MR for measurement is supported, wherein
the first delay is a switching delay of the terminal or the main receiver of the terminal to switch from an ultra-deep sleep state to a normal receiving state, and the second delay is a wake-up delay of the terminal or the main receiver of the terminal.

14. A method for enabling a wake-up signal function, comprising:
performing, by a core network device, a target operation, wherein
the target operation comprises any one of following:
sending first information to a terminal; or
sending fourth information to an access network device, wherein the fourth information is used to assist the access network device in sending second information to the terminal, wherein
the first information is used to indicate to enable a wake-up signal function of the terminal, and the second information is used to indicate a type of a terminal that enables or does not enable a wake-up signal function in terminals that access a cell corresponding to the access network device.

15. The method according to claim 14, wherein the second information comprises any one of following:
first indication information, wherein the first indication information is used to indicate that the cell corresponding to the access network device sends a wake-up signal only to or only not to a terminal of a target terminal type;
second indication information, wherein the second indication information is used to indicate that only the terminal of the target terminal type enables or does not enable a wake-up signal function in the cell corresponding to the access network device; and
a first type set, wherein the first type set comprises a type of a terminal that is capable of enabling a wake-up signal function in the cell corresponding to the access network device.

16. The method according to claim 14, wherein when the target operation comprises sending the first information to the terminal, the performing, by a core network device, a target operation comprises:
obtaining, by the core network device, a terminal type of the terminal; and
when the terminal type of the terminal is a target terminal type, sending, by the core network device, the first information to the terminal.

17. The method according to claim 16, wherein the obtaining, by the core network device, a terminal type of the terminal comprises any one of following:
obtaining, by the core network device, UE assistance information, and determining the terminal type of the terminal based on the UE assistance information; or
receiving, by the core network device, sixth indication information from the access network device, wherein the sixth indication information is used to indicate the terminal type of the terminal.

18. The method according to claim 17, wherein the UE assistance information comprises at least one of following:
the terminal type;
first capability information, wherein the first capability information is used to indicate whether the wake-up signal function is supported;
an access delay requirement;
a first delay, wherein the first delay is a switching delay for the terminal or a main receiver of the terminal to switch from an ultra-deep sleep state to a normal receiving state;
a second delay, wherein the second delay is a wake-up delay of the terminal or the main receiver of the terminal;
a power saving requirement; or
second capability information, wherein the second capability information is used to indicate whether using both a wake-up receiver WUR and a main receiver MR for measurement is supported.

19. The method according to claim 14, further comprising:
sending, by the core network device, a paging message to the access network device, wherein
the paging message is used to determine whether to send a wake-up signal, and the paging message comprises at least one of following:
UE assistance information of a paged terminal;
a terminal type of a paged terminal;
whether a paged terminal is the target terminal type; or
whether a paged terminal enables a wake-up signal function.

20. The method according to claim 15, wherein the target terminal type meets at least one of following:
the wake-up signal function is supported;
an access delay is greater than or equal to first preset duration, or an access delay is equal to first preset duration, or an access delay is less than or equal to first preset duration;
a first delay is greater than or equal to second preset duration, or a first delay is equal to second preset duration, or a first delay is less than or equal to second preset duration;
a second delay is greater than or equal to third preset duration, or a second delay is equal to third preset duration, or a second delay is less than or equal to third preset duration;
a power saving capability is greater than or equal to a preset threshold; or
using both a WUR and an MR for measurement is supported, wherein
the first delay is a switching delay of the terminal or the main receiver of the terminal to switch from an ultra-deep sleep state to a normal receiving state, and the second delay is a wake-up delay of the terminal or the main receiver of the terminal.
